(19) United States
(12) Patent Application Publication
(10) Pub. No.: US 2026/0358912 A1
(43) Pub. Date: Nov. 12, 2026

(54) MOUSE AND PRESS ROTATION SWITCHING TYPE SCROLL WHEEL MODULE THEREOF

(71) Applicant: Voyetra Turtle Beach, Inc., San Diego, CA (US)

(72) Inventors: Wei Chuan WANG, New Taipei City (TW); Thaddaeus Erasmus Georg Richard TETZNER, Hamburg (DE); Ying Chieh HUNG, New Taipei City (TW); Chih Wei HUNG, New Taipei City (TW)

(73) Assignee: Voyetra Turtle Beach, Inc., San Diego, CA (US)

(21) Appl. No.: 19/155,358

(22) PCT Filed: Feb. 16, 2024
(86) PCT No.: PCT/US2024/016171

§ 371 Date: Aug. 11, 2025

(30) Foreign Application Priority Data
Feb. 16, 2023 (TW) 112105622
Feb. 16, 2023 (TW) 112201351
Mar. 8, 2023 (CN) 202310216947.5
Mar. 8, 2023 (CN) 202320422497.0

(51) Int. Cl. G06F 3/0362; G06F 3/0354

(52) U.S. Cl. CPC G06F 3/0362; G06F 3/03543

(57) ABSTRACT

A scroll-wheel module comprises a frame body and a scroll wheel rotatably supported on the frame body, the scroll wheel including a plurality of scroll wheel teeth arranged circumferentially for rotation along a defined path. The module further includes a press rotation mechanism having a press component, a sleeve fixed to the frame body, and a rotation component rotatably disposed therein. The press component may drive the rotation component, which comprises at least one stop portion and at least one receiving space. An oscillation arm is rotatably connected to the frame body, with a first end including a push rod and a second end including an action portion. The action portion selectively engages the stop portion or the receiving space to position the push rod on or outside the rotation path. An action elastic element is disposed between the action portion and the frame body to facilitate engagement and disengagement.

### CROSS-REFERENCE TO RELATED APPLICATIONS

This application claims the benefit of Taiwan Patent Application No. 112105622, filed Feb. 16, 2023, Taiwan Patent Application No. 112201351, filed Feb. 16, 2023 (which issued as Taiwan Patent No. M645239 on Aug. 21, 2023), Chinese Patent Application No. 202310216947.5, filed Mar. 8, 2023, and Chinese Patent Application No. 202320422497.0, filed Mar. 8, 2023 (which issued as Chinese Patent No. ZL 202320422497.0 on August 22, 2023), which are hereby incorporated herein by reference in their entirety.

### TECHNICAL FIELD

The present disclosure relates to scroll wheels of mouses, and in particular some aspects relate to a mouse and a press rotation switching type scroll wheel module thereof.

### BACKGROUND ART

A mouse includes a housing and a scroll wheel assembly arranged in the housing. A user can control a page scroll bar displayed on a screen to scroll up and down or left and right by rolling a scroll wheel in the scroll wheel assembly.

To provide the user with an effect of detent scrolling when rolling the scroll wheel, an existing seesaw switching type detent scrolling structure mainly includes a main frame, a microswitch, an elastic press structure, a seesaw structure, a movable arm, and a scroll wheel. The elastic press structure is fixedly arranged on the main frame and can be pressed to ascend or descend elastically; the scroll wheel is rotatably connected to the main frame and has an outwardly protruding gear protruding laterally; the movable arm has one end rotatably connected to the main frame and the other end corresponding to the outwardly protruding gear; and the seesaw structure is rotatably connected to the main frame and has two ends corresponding to the microswitch and disposed between two ends of the movable arm, respectively.

In this way, when switching to a detent scrolling state, a seesaw-like counterclockwise seesaw action is generated by pressing the seesaw structure so as to press the elastic press structure, so that the elastic press structure descends elastically and the seesaw structure performs the counterclockwise seesaw action accordingly. As a result, the seesaw structure no longer presses the movable arm, and the movable arm oscillates upwards counterclockwise by a torsion spring to be engaged at a tooth gap of the outwardly protruding gear, thus switching to the detent scrolling state. On the contrary, when the seesaw structure is pressed again, the elastic press structure ascends elastically and drives the seesaw structure to perform a clockwise seesaw action, so that the seesaw structure presses the movable arm to descend and prevents the movable arm from contacting the outwardly protruding gear, thus switching to a non-detent scrolling state.

However, the existing seesaw switching type detent scrolling structure mentioned above is complex due to a large number of components, and the volume of the existing seesaw switching type detent scrolling structure is correspondingly increased because the outwardly protruding gear must protrude out of the scroll wheel, making it difficult for the existing seesaw switching type detent scrolling structure to be applicable to an existing mouse.

### SUMMARY

Examples disclosed herein provide a mouse and a press rotation switching type scroll wheel module thereof. Embodiments may be configured to reduce the number of components, and to achieve good detent scrolling performance by direct contact between a push rod and scroll wheel teeth of a scroll wheel, thereby reducing the volume of the press rotation switching type scroll wheel module, and accordingly allowing the press rotation switching type scroll wheel module to be applicable to an existing mouse.

Implementations may provide a press rotation switching type scroll wheel module, that may include: a frame body; a scroll wheel, rotatably erected on the frame body and having a plurality of scroll wheel teeth around one another, where the plurality of scroll wheel teeth rotate with the scroll wheel and jointly have a rotation path; a press rotation mechanism that may include a press component, a sleeve, and a rotation component, where the sleeve is fixed to the frame body, the rotation component is rotatably arranged in the sleeve, the press component may be movably arranged in the sleeve and drive the rotation component to rotate, and the rotation component may include at least one stop portion and at least one receiving space or portion; and an oscillation arm, rotatably connected to the frame body and having two ends thereof provided with a push rod and an action portion, respectively, where the action portion selectively acts on the stop portion and the receiving space to enable the push rod to be located on and outside the rotation path, respectively, and an action elastic element is arranged between the action portion and the frame body.

Further examples may include a mouse that includes: a housing, having an internal space; and a press rotation switching type scroll wheel module as described above, where the press rotation switching type scroll wheel module is received in the internal space, the frame body is fixed to the housing, and the scroll wheel is partially exposed outside the housing. In some implementations, the mouse may include a housing, having an internal space. In addition, the mouse may include a scroll wheel module within the housing, the scroll wheel module having a frame body; a scroll wheel, rotatably erected on the frame body and having a plurality of scroll wheel teeth around one another, where the plurality of scroll wheel teeth rotate with the scroll wheel and jointly have a rotation path; a press rotation mechanism, having a press component, a sleeve, and a rotation component, where the sleeve is fixed to the frame body, the rotation component is rotatably arranged in the sleeve, the press component is movably arranged in the sleeve and drives the rotation component to rotate, and the rotation component has at least one stop portion and at least one receiving space; and an oscillation arm, rotatably connected to the frame body and having two ends thereof provided with a push rod and an action portion, respectively, where the action portion selectively acts on the stop portion and the at least one receiving space to enable the push rod to be located on and outside the rotation path, respectively, and an action elastic element is arranged between the action portion and the frame body.

Various examples may have the following effects: the number of components can be reduced over conventional solutions, and good detent scrolling performance can be achieved by direct contact between the push rod and the scroll wheel teeth of the scroll wheel. As a result, the volume of the press rotation switching type scroll wheel module can be reduced, thus allowing the press rotation switching type scroll wheel module to be applicable to an existing mouse. In addition, by means of the press rotation mechanism and specific structure configurations, the push rod of the oscillation arm can be switched between being in contact with the scroll wheel teeth and not being in contact with the scroll wheel teeth.

### DESCRIPTION OF THE DRAWINGS

FIG. 1 is a schematic exploded perspective view of a first example embodiment of a scroll wheel module at a viewing angle.

FIG. 2 is schematic exploded perspective view of the example first embodiment of the scroll wheel module at another viewing angle.

FIG. 3 is an enlarged view of an example press component and a rotation component of the scroll wheel module according to FIG. 1.

FIG. 4 is a schematic combined perspective view of the example scroll wheel module according to FIG. 1.

FIG. 5 is a schematic combined perspective view of the example scroll wheel module according to FIG. 2.

FIG. 6 is a schematic sectional view of the first embodiment of the example scroll wheel module after combination at a viewing angle.

FIG. 7 is schematic sectional view of the first embodiment of the example scroll wheel module after combination at another viewing angle.

FIG. 8A is a schematic perspective view of the press component, the rotation component, and a cover plate of the example scroll wheel module combining with each other according to FIG. 1.

FIG. 8B is a schematic sectional view of the scroll example wheel module according to FIG. 8A.

FIG. 9 is a schematic perspective view of the example scroll wheel module after press rotation according to FIG. 4.

FIG. 10 is a schematic perspective view of the example scroll wheel module after press rotation according to FIG. 5.

FIG. 11 is a schematic sectional view of the example scroll wheel module according to FIG. 9 at a viewing angle.

FIG. 12 is schematic sectional view of the example scroll wheel module according to FIG. 9 at another viewing angle.

FIG. 13 is a schematic perspective view of a second embodiment of the example scroll wheel module.

FIG. 14 is a schematic perspective view of the example scroll wheel module after press rotation according to FIG. 13.

FIG. 15 is a schematic lateral view of an example mouse.

### Description of signs in the drawings

100: scroll wheel module;
1: frame body;
2: scroll wheel;
21: rotation shaft;
22: recessed chamber;
23: inner periphery;
231: scroll wheel teeth;
3: press rotation mechanism;
31: sleeve;
311: cover plate;
311a: first outer ring tooth;
312: insertion hole;
3121: guide groove;
3122: limit inner wall;
32: press component;
32a: first inner ring teeth;
321: guide strip;
323: limit surface;
324: shaft column;
33: rotation component;
331: rotation body;
3311: shaft hole;
332: straight-line-shaped protrusion;
3321: stop portion;
3322: receiving space;
333b: second inner ring teeth;
334b: second outer ring teeth;
336: cross-shaped protrusion;
3361: stop portion;
3362: receiving space;
34: press elastic element;
4: oscillation arm;
41: push rod;
42: action portion;
421: board body;
422: opening;
4221: inner edge;
4223: protruding key;
423: action elastic element;
900: housing;
D: rotation path;
S: internal space.

### DETAILED DESCRIPTION OF THE PREFERRED EMBODIMENTS

The detailed description and technical content of the disclosure are illustrated below in conjunction with the accompanying drawings. However, the accompanying drawings are for reference and explanation only and are not intended to limit the scope.

Embodiments may include a mouse and a press rotation switching type scroll wheel module thereof. As shown in FIG. 15, the mouse may include a press rotation switching type scroll wheel module (hereinafter referred to as the scroll wheel module) 100 and a housing 900, where the scroll wheel module 100 is arranged in the housing 900.

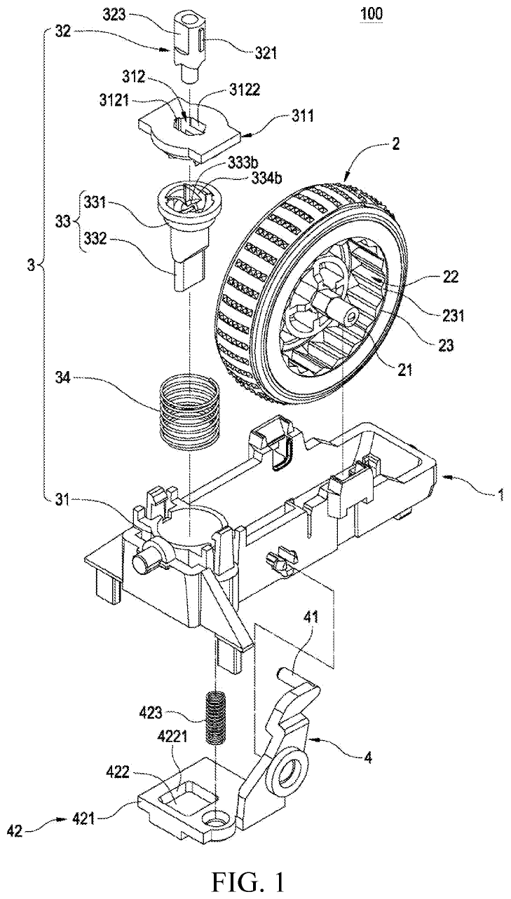

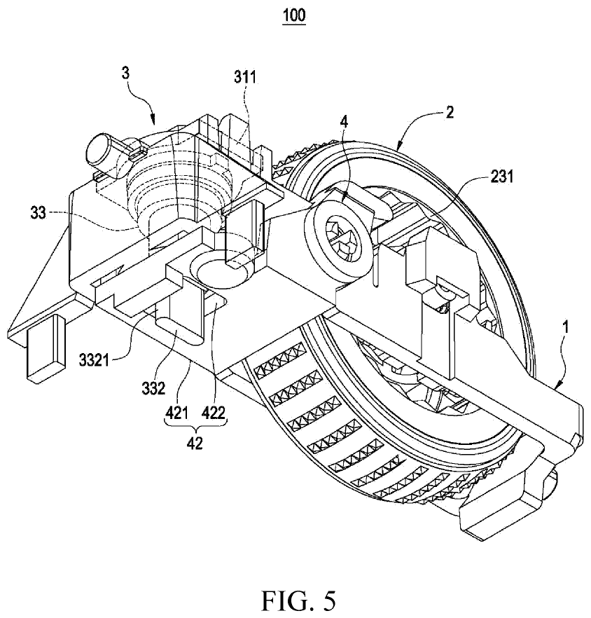

As shown in the example of FIG. 1 to FIG. 7, which refer to a first embodiment of the scroll wheel module 100, the scroll wheel module includes a frame body 1, a scroll wheel 2, a press rotation mechanism 3, and an oscillation arm 4.

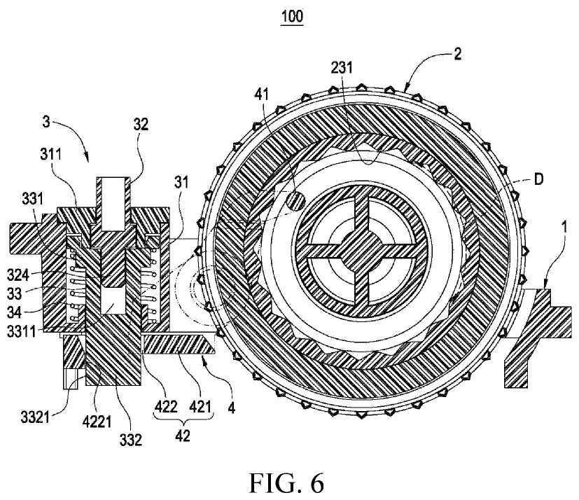

The scroll wheel 2 has a rotation shaft 21 and a plurality of scroll wheel teeth 231 around one another, and the rotation shaft 21 is surrounded by the plurality of scroll wheel teeth 231. The scroll wheel 2 is rotatably erected on the frame body 1 through the rotation shaft 21, and the plurality of scroll wheel teeth 231 can rotate with the scroll wheel 2 and jointly have a rotation path D (see FIG. 6). It should be noted that in an embodiment, a recessed chamber 22 is formed on one surface of the scroll wheel 2, and an inner periphery 23 is formed at a position, corresponding to the recessed chamber 22, on the scroll wheel 2, and all of the plurality of scroll wheel teeth 231 protrude from the inner periphery 23 in a direction toward the rotation shaft 21.

The press rotation mechanism 3 includes a sleeve 31, a press component 32, and a rotation component 33. In an embodiment, the press rotation mechanism further includes a press elastic element 34.

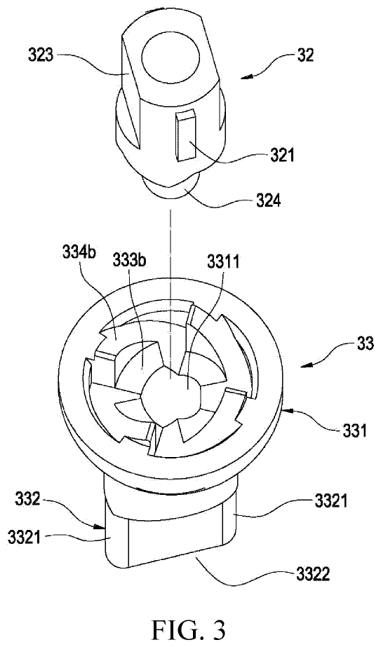

The sleeve 31 is fixed to the frame body 1, so that the sleeve 31 is located at a position relative to the scroll wheel 2. A cover plate 311 may be fixed to an upper sleeve opening of the sleeve 31 as shown in the figure, or a cover plate (not shown in the figure) is integrally formed on an upper sleeve opening of the sleeve originally. In this embodiment, the former is used as an example for description. A bottom seal plate (see FIG. 6, not marked with a reference numeral) that allows the rotation component 33 to extend therefrom is integrally formed on a lower sleeve opening of the sleeve 31. The rotation component 33 is rotatably arranged in the sleeve 31 and partially extends out of the bottom seal plate. The part of the rotation component 33 that partially extends out of the bottom seal plate has at least one stop portion 3321 and at least one receiving space 3322 as shown in FIG. 3. The press component 32 is movably inserted in the cover plate 311 in an extendable and retractable manner and extends into the sleeve 31 to drive the rotation component 33 to rotate relative to the sleeve 31. In an embodiment, the press elastic element 34 is sleeved on the rotation component 33 and elastically supported between the rotation component 33 and the bottom seal plate of the sleeve 31.

It should be noted that a rotation angle of each press rotation of the press rotation mechanism 3 is not limited and may be any rotation angle such as 45° or 90°. In this embodiment, 90° is used as an example for description. The rotation component 33 may include a straight-line-shaped protrusion 332, and the straight-line-shaped protrusion 332 has two opposite side edges disposed opposite to each other as shown in FIG. 3. The two opposite side edges are equivalent to the two stop portions 3321, and two receiving spaces 3322 are formed at two opposite surfaces of the straight-line-shaped protrusion 332.

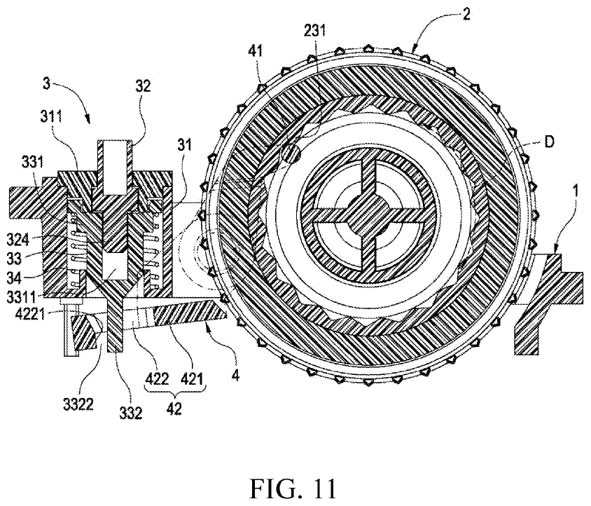

In this way, when a user presses the press component 32, the rotation component 33 can be driven to rotate 90° relative to the sleeve 31 as shown in FIG. 6 and FIG. 11. Each time the rotation component 33 rotates 90°, an action portion 42 of the oscillation arm 4 to be described below is caused to act on the stop portion 3321, the receiving space 3322, the stop portion 3321, and the receiving space 3322 sequentially in a cycle.

The oscillation arm 4 is rotatably connected to the frame body 1, so that the oscillation arm 4 can perform an action like a seesaw (hereinafter referred to as a seesaw action) using the connection location as the axis. A push rod 41 and an action portion 42 are provided at two ends of the oscillation arm 4, respectively. The action portion 42 may be blocked by the stop portion 3321 and received in the receiving space 3322 before and after the seesaw action, respectively, to enable the push rod 41 to be located on and outside the rotation path D before and after the seesaw action, respectively. In other words, the oscillation arm 4 is bridged between the scroll wheel teeth 231 of the scroll wheel 2 and the straight-line-shaped protrusion 332 of the rotation component 33 by the push rod 41 and the action portion 42. In an embodiment, an action elastic element 423 is elastically supported between the action portion 42 and the frame body 1; and the push rod 41 extends into the recessed chamber 22 of the scroll wheel 2.

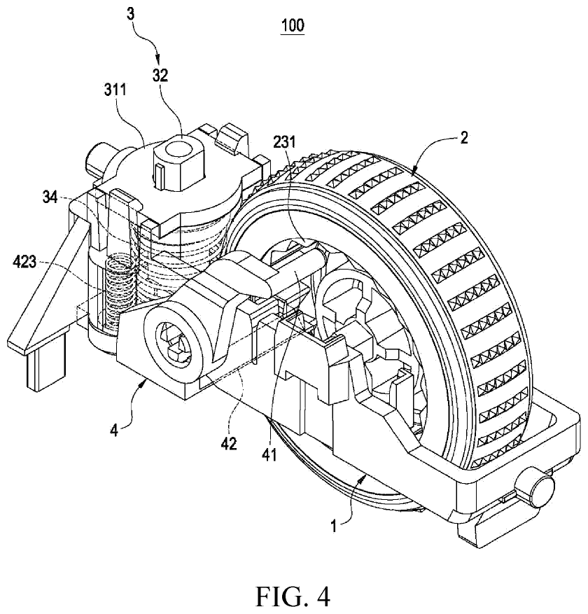

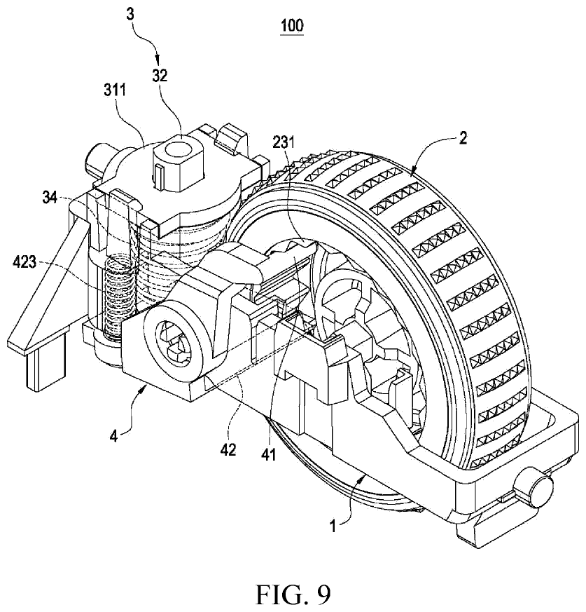

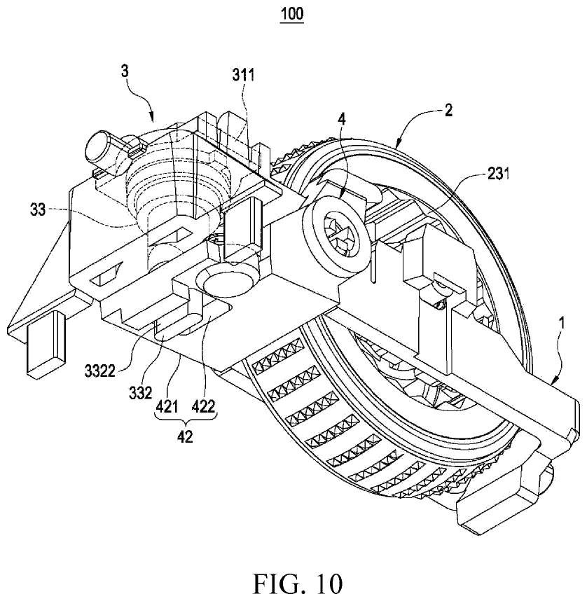

As shown in FIG. 4 to FIG. 7, when the press rotation mechanism 3 is pressed to rotate 90° to switch to a state where the straight-line-shaped protrusion 332 blocks the action portion 42 by the stop portion 3321 thereof, the oscillation arm 4 cannot oscillate due to the blocking by the stop portion 3321, so that the push rod 41 is still located outside the rotation path D and cannot contact any of the scroll wheel teeth 231, thus allowing the user to roll the scroll wheel 2 such that the scroll wheel rotates quickly. As shown in FIG. 9 to FIG. 12, when the press rotation mechanism 3 is pressed to rotate 90° again to switch to a state where the straight-line-shaped protrusion 332 receives the action portion 42 by the receiving space 3322 thereof, the oscillation arm 4 becomes loose because the oscillation arm is no longer blocked, so that the action elastic element 423 can elastically push the oscillation arm 4 to perform a seesaw action and oscillate, and then the push rod 41 is enabled to move onto the rotation path D to contact the scroll wheel teeth 231. In this way, when the user rolls the scroll wheel 2, the scroll wheel 2 already cannot rotate quickly, and each scroll wheel tooth 231 pushes the push rod 41 so as to achieve better detent scrolling performance.

In this way, the number of components can be reduced (e.g., compared with prior art), and the push rod 41 can directly contact the scroll wheel teeth 231 of the scroll wheel 2 to achieve good detent scrolling performance, so that the volume of the scroll wheel module 100 can be reduced, thus allowing the scroll wheel module 100 to be applicable to an existing mouse. Furthermore, by means of the press rotation mechanism 3 and special structural configurations, the push rod 41 of the oscillation arm 4 can be switched between being in contact with the scroll wheel teeth 231 and not being in contact with the scroll wheel teeth 231. When the push rod is switched to be in contact with the scroll wheel teeth 231, better detent scrolling performance can be achieved since the push rod directly contacts the scroll wheel teeth 231. When the push rod is switched to not be in contact with the scroll wheel teeth 231, the user can roll the scroll wheel 2 such that the scroll wheel rotates quickly due to no blocking.

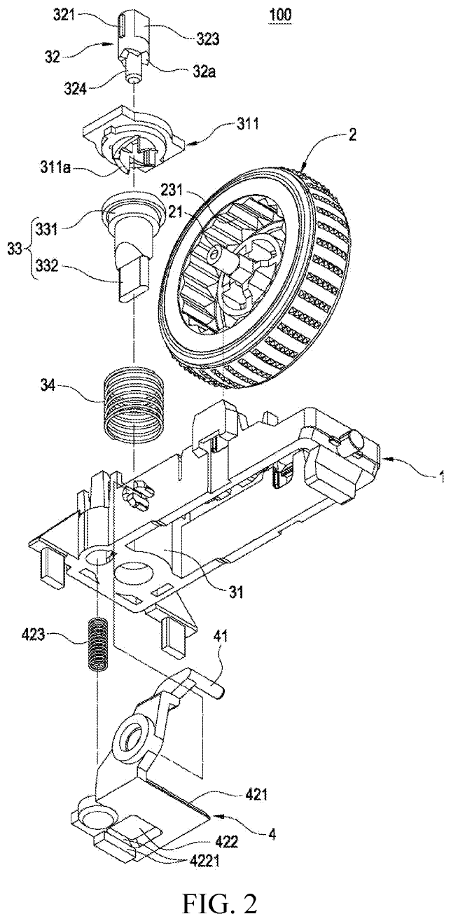

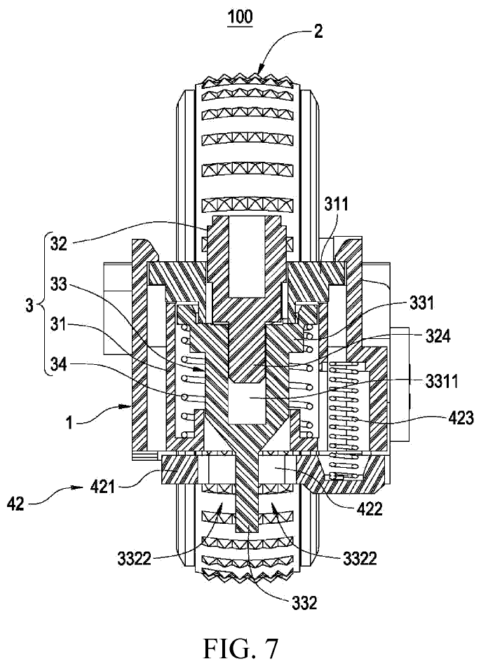

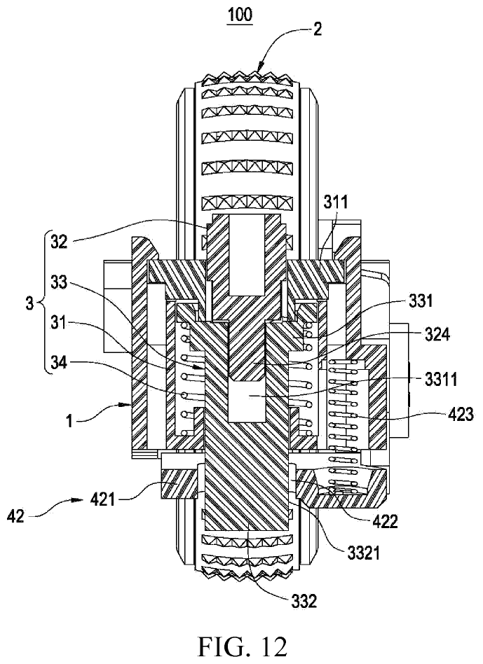

In detail, as shown in FIG. 1 and FIG. 2, the action portion 42 may include a board body 421 and an opening 422 provided on the board body 421, and a plurality of inner edges 4221 around one another are formed at a position, corresponding to the opening 422, on the board body 421. The board body 421 is correspondingly located below the lower sleeve opening of the sleeve 31, and the action elastic element 423 is arranged between the board body 421 and the frame body 1 as shown in FIG. 7 or FIG. 12. The straight-line-shaped protrusion 332 extends into the opening 422, so that the action portion 42 can be blocked by the stop portion 3321 through one of the plurality of inner edges 4221 as shown in FIG. 6, or can enter the receiving space 3322 by the same inner edge 4221 after the oscillation arm 4 oscillates as shown in FIG. 11.

Still as shown in FIG. 1 and FIG. 2, the cover plate 311 is provided with an insertion hole 312, and the press component 32 is inserted in the insertion hole 312 in an extendable and retractable manner and is engaged at (or restricted by) the insertion hole 312 and cannot rotate. In detail, two limit inner walls 3122 opposite to each other are arranged at a position, corresponding to the insertion hole 312, on the cover plate 311, and the press component 32 has two limit surfaces 323 corresponding to the limit inner walls 3122, so as to prevent the press component 32 from rotating relative to the cover plate 311. Furthermore, two guide grooves 3121 opposite to each other are further provided at the position, corresponding to the insertion hole 312, on the cover plate 311, and the press component 32 has two guide strips 321 correspondingly connected to the guide grooves 3121 in a sliding manner, so as to guide the press component 32 to extend or retract relative to the cover plate 311.

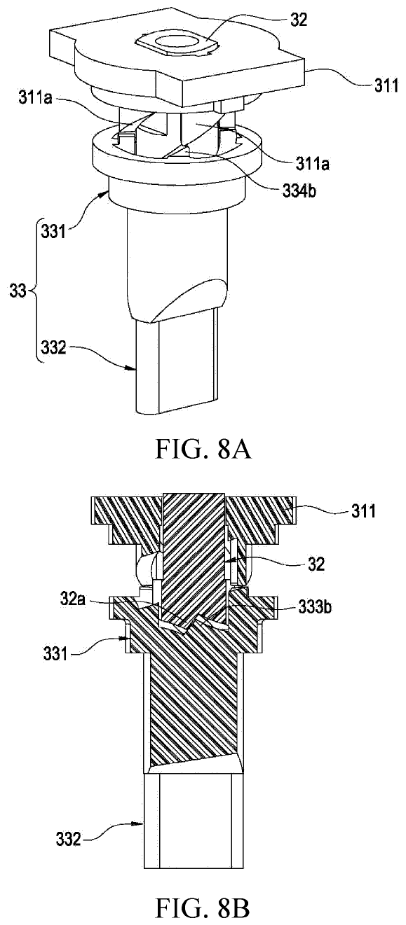

As shown in FIG. 1 to FIG. 3 as well as FIG. 8A and FIG. 8B, the press rotation mechanism 3 can be pressed to rotate 90° each time due to the following configuration: a shaft column 324 and first inner ring teeth 32 a protrude from a lower end surface of the press component 32, and the first inner ring teeth 32 a surround the shaft column 324; first outer ring teeth 311a correspondingly surrounding the insertion hole 312 protrude from an inner surface of the cover plate 311; and second inner ring teeth 333b and second outer ring teeth 334b are arranged on the rotation component 33. In detail, the rotation component 33 further includes a rotation body 331, the straight-line-shaped protrusion 332 is formed by integrally extending from a lower end of the rotation body 331, the rotation body 331 is internally provided with a shaft hole 3311 and has the second inner ring teeth 333b and the second outer ring teeth 334b, and the second inner ring teeth 333b and the second outer ring teeth 334b coaxially surround the shaft hole 3311, where the second inner ring teeth 333b correspond to and mesh with the first inner ring teeth 32a, and the second outer ring teeth 334b correspond to and mesh with the first outer ring teeth 311a.

In this way, each time the user presses the press component 32, the rotation component 33 can be driven to rotate 90° relative to the sleeve 31.

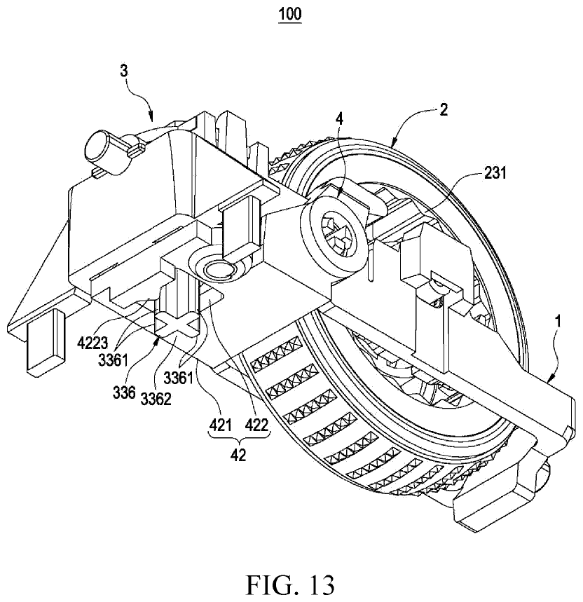

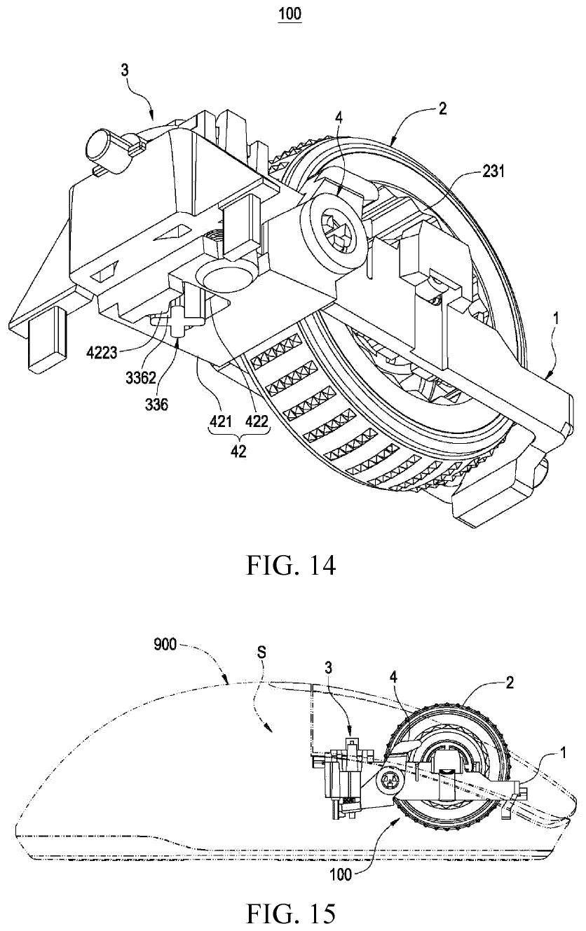

FIG. 13 and FIG. 14 show a second embodiment of the scroll wheel module 100. The second embodiment is generally the same as the first embodiment mentioned above, and only the rotation angle of each press rotation of the press rotation mechanism 3 is configured to be 45°. As a result, the protrusion of the rotation component 33, the action portion 42, each inner ring tooth, and each outer ring tooth need to be configured differently.

A cross-shaped protrusion 336 integrally extends from the lower end of the rotation body 331 of the rotation component 33. The cross-shaped protrusion 336 has two groups of two side edges opposite to each other. The two groups have a total of four side edges, which are equivalent to four stop portions 3361, and a recess between any two adjacent side edges is one of four receiving spaces 3362. The cross-shaped protrusion 336 also correspondingly extends into the opening 422 of the action portion 42.

A protruding key 4223 further protrudes from the inner edge 4221 of the board body 421. The protruding key 4223 corresponds to the receiving space 3362.

In this way, when the rotation component 33 rotates 45°, the protruding key 4223 of the oscillation arm 4 is caused to act on the stop portion 3361, the receiving space 3362, the stop portion 3361, the receiving space 3362, . . . sequentially in a cycle. As shown in FIG. 13, after the user presses the press rotation mechanism 3 to rotate 45°, the protruding key 4223 of the action portion 42 can be blocked by any stop portion 3361 to prevent the oscillation arm 4 from oscillating, such that the push rod 41 is located outside the rotation path D and cannot contact the scroll wheel teeth 231. As shown in FIG. 14, after the user presses the press rotation mechanism to rotate 45° again, the protruding key 4223 can be received in the receiving space 3362 after the oscillation arm 4 oscillates, then the push rod 41 moves onto the rotation path D to contact the scroll wheel teeth 231, and each scroll wheel tooth 231 pushes the push rod 41 so as to achieve better detent scrolling performance.

It should be noted that according to the second embodiment of the scroll wheel module 100, the number of the first inner ring teeth, the number of the first outer ring teeth, the number of the second inner ring teeth, and the number of the second outer ring teeth (not shown in the figure) are twice those in the first embodiment, to implement the press rotation of 45°.

As shown in FIG. 15, the housing 900 has an internal space S, the scroll wheel module 100 is received in the internal space S, the scroll wheel 2 is partially exposed outside the housing 900, and the frame body 1 is fixed to the housing 900.

In summary, the mouse and the press rotation switching type scroll wheel module thereof may be implemented in such a way to achieve the expected purpose of use and overcome the shortcomings in conventional solutions.

The above are examples of feasible embodiments of the present disclosure, and do not limit the scope of the claims. It should be noted that any equivalent structural changes made by using the description and drawings of the present disclosure shall be included in the scope of the present disclosure.

1. A scroll wheel module, characterized by comprising:
a frame body;
a scroll wheel, rotatably disposed on the frame body and comprising a plurality of scroll wheel teeth, wherein the plurality of scroll wheel teeth rotate with the scroll wheel along a rotation path;
a press rotation mechanism, comprising a press component, a sleeve, and a rotation component, wherein the sleeve is fixed to the frame body, the rotation component is rotatably disposed in the sleeve, the press component is movably disposed in the sleeve and is configured to drive the rotation component to rotate, and the rotation component comprises at least one stop portion and at least one receiving space; and
an oscillation arm, rotatably connected to the frame body and comprising first and second ends comprising a push rod and an action portion, respectively, wherein the action portion selectively acts on the stop portion and the at least one receiving space to enable the push rod to be located on and outside the rotation path, and an action elastic element is disposed between the action portion and the frame body.

2. The scroll wheel module according to claim 1, wherein a rotation angle of each press rotation of the press rotation mechanism is 90°, the rotation component comprises a straight-line-shaped protrusion comprising two opposite side edges opposite to each other, and two of the at least one receiving space are formed at two opposite surfaces of the straight-line-shaped protrusion.

3. The scroll wheel module according to claim 2, wherein the action portion comprises a board body and an opening provided on the board body, the straight-line-shaped protrusion extends into the opening, a plurality of inner edges around one another are formed at a position, corresponding to the opening, on the board body, the action portion is blocked by the stop portion or enters the at least one receiving space through one of the plurality of inner edges, and the action elastic element is disposed between the board body and the frame body.

4. The scroll wheel module according to claim 2, wherein the press rotation mechanism further comprises a press elastic element, a cover plate fixed to one end of the sleeve and provided with an insertion hole, the press component is inserted into the insertion hole and is engaged at the insertion hole, the press component comprising first inner ring teeth, first outer ring teeth around a position corresponding to the insertion hole are provided on an inner surface of the cover plate, the rotation component further comprises a rotation body, second inner ring teeth and second outer ring teeth that correspond to and mesh with the first inner ring teeth and the first outer ring teeth, respectively, are provided in the rotation body, and the press elastic element is sleeved on the rotation component and elastically supported between the rotation component and the other end of the sleeve.

5. The scroll wheel module according to claim 1, wherein a rotation angle of each press rotation of the press rotation mechanism is 45°, the rotation component comprises a cross-shaped protrusion comprising two groups of two side edges, and the two side edges in each group are opposite to each other.

6. The scroll wheel module according to claim 5, wherein the action portion comprises a board body and an opening provided on the board body, the cross-shaped protrusion extends into the opening, a plurality of inner edges around one another are formed at a position, corresponding to the opening, on the board body, a protruding key protrudes from one of the plurality of inner edges, the action portion is blocked by the stop portion or extends into the at least one receiving space through the protruding key, and the action elastic element is disposed between the board body and the frame body.

7. The scroll wheel module according to claim 5, wherein the press rotation mechanism further comprises a press elastic element, a cover plate is fixed to one end of the sleeve, the cover plate is provided with an insertion hole, the press component is inserted into the insertion hole and is engaged at the insertion hole, the press component comprising first inner ring teeth, first outer ring teeth around a position corresponding to the insertion hole are provided on an inner surface of the cover plate, the rotation component further comprises a rotation body, second inner ring teeth and second outer ring teeth that correspond to and mesh with the first inner ring teeth and the first outer ring teeth, respectively, are provided in the rotation body, and the press elastic element is sleeved on the rotation component and elastically supported between the rotation component and the other end of the sleeve.

8. The scroll wheel module according to claim 1, wherein the oscillation arm is bridged between the rotation component and the scroll wheel teeth by the push rod and the action portion.

9. The scroll wheel module according to claim 1, wherein a recessed chamber is formed on a surface of the scroll wheel, the scroll wheel is formed with an inner periphery corresponding to the recessed chamber, the plurality of scroll wheel teeth protrude from the inner periphery, and the push rod extends into the recessed chamber.

10. A mouse, comprising:
a housing, comprising an internal space; and
a scroll wheel module within the housing, the scroll wheel module comprising a frame body;
a scroll wheel, rotatably erected on the frame body and comprising a plurality of scroll wheel teeth around one another, wherein the plurality of scroll wheel teeth rotate with the scroll wheel and jointly have a rotation path;
a press rotation mechanism, comprising a press component, a sleeve, and a rotation component, wherein the sleeve is fixed to the frame body, the rotation component is rotatably disposed in the sleeve, the press component is movably disposed in the sleeve and drives the rotation component to rotate, and the rotation component comprises at least one stop portion and at least one receiving space; and
an oscillation arm, rotatably connected to the frame body and comprising two ends thereof provided with a push rod and an action portion, respectively, wherein the action portion selectively acts on the stop portion and the at least one receiving space to enable the push rod to be located on and outside the rotation path, respectively, and an action elastic element is disposed between the action portion and the frame body.

11. The mouse according to claim 10, wherein a rotation angle of each press rotation of the press rotation mechanism is 90°, and the rotation component comprises a straight-line-shaped protrusion comprising two opposite side edges opposite to each other

12. The mouse according to claim 11, wherein the action portion comprises a board body and an opening provided on the board body, the straight-line-shaped protrusion extends into the opening, a plurality of inner edges around one another are formed at a position, corresponding to the opening, on the board body, the action portion is blocked by the stop portion or enters the at least one receiving space through one of the plurality of inner edges, and the action elastic element is disposed between the board body and the frame body.

13. The mouse according to claim 11, wherein the press rotation mechanism further comprises a press elastic element, a cover plate is fixed to one end of the sleeve, the cover plate is provided with an insertion hole, the press component is inserted into the insertion hole and is engaged at the insertion hole, the press component comprising first inner ring teeth, first outer ring teeth around a position corresponding to the insertion hole are provided on an inner surface of the cover plate, the rotation component further comprises a rotation body, second inner ring teeth and second outer ring teeth that correspond to and mesh with the first inner ring teeth and the first outer ring teeth, respectively, are provided in the rotation body, and the press elastic element is sleeved on the rotation component and elastically supported between the rotation component and the other end of the sleeve.

14. The mouse according to claim 10, wherein a rotation angle of each press rotation of the press rotation mechanism is 45°, the rotation component comprises a cross-shaped protrusion comprising two groups of two side edges, and the two side edges in each group are opposite to each other.

15. The mouse according to claim 14, wherein the action portion comprises a board body and an opening provided on the board body, the cross-shaped protrusion extends into the opening, a plurality of inner edges around one another are formed at a position, corresponding to the opening, on the board body, a protruding key protrudes from one of the plurality of inner edges, the action portion is blocked by the stop portion or extends into the at least one receiving space through the protruding key, and the action elastic element is disposed between the board body and the frame body.

16. The mouse according to claim 14, wherein the press rotation mechanism further comprises a press elastic element, a cover plate is fixed to one end of the sleeve, the cover plate is provided with an insertion hole, the press component is inserted into the insertion hole and is engaged at the insertion hole, the press component comprising first inner ring teeth, first outer ring teeth around a position corresponding to the insertion hole are provided on an inner surface of the cover plate, the rotation component further comprises a rotation body, second inner ring teeth and second outer ring teeth that correspond to and mesh with the first inner ring teeth and the first outer ring teeth, respectively, are provided in the rotation body, and the press elastic element is sleeved on the rotation component and elastically supported between the rotation component and the other end of the sleeve.

17. The mouse according to claim 10, wherein the oscillation arm is bridged between the rotation component and the scroll wheel teeth by the push rod and the action portion.

18. The mouse according to claim 10, wherein a recessed chamber is formed on a surface of the scroll wheel, the scroll wheel is formed with an inner periphery corresponding to the recessed chamber, the plurality of scroll wheel teeth protrude from the inner periphery, and the push rod extends into the recessed chamber.
